(19) United States
(12) Patent Application Publication
(10) Pub. No.: US 2022/0391724 A1
(43) Pub. Date: Dec. 8, 2022

(54) Unsupervised Anomaly Detection With Self-Trained Classification

(71) Applicant: Google LLC, Mountain View, CA (US)

(72) Inventors: Jinsung Yoon, San Jose, CA (US); Kihyuk Sohn, Mountain View, CA (US); Chun-Liang Li, Mountain View, CA (US); Sercan Omer Arik, San Francisco, CA (US)

(21) Appl. No.: 17/825,788

(22) Filed: May 26, 2022

Related U.S. Application Data
(60) Provisional application No. 63/193,875, filed on May 27, 2021.

(51) Int. Cl. G06N 5/04; G06F 11/34

(52) U.S. Cl. CPC G06N 5/04; G06F 11/3495

(57) ABSTRACT

Aspects of the disclosure provide for methods, systems, and apparatus, including computer-readable storage media, for anomaly detection using a machine learning framework trained entirely on unlabeled training data including both anomalous and non-anomalous training examples. A self-supervised one-class classifier (STOC) refines the training data to exclude anomalous training examples, using an ensemble of machine learning models. The ensemble of models are retrained on the refined training data. The STOC can also use the refined training data to train a representation learning model to generate one or more feature values for each training example, which can be processed by the trained ensemble of models and eventually used for training an output classifier model to predict whether input data is indicative of anomalous or non-anomalous data.

### CROSS-REFERENCE TO RELATED APPLICATIONS

This application claims the benefit under 35 U.S.C. § 119(e) of the filing date of U.S. Patent Application No. 63/193,875, for UNSUPERVISED ANOMALY DETECTION WITH SELF-TRAINED CLASSIFICATION, which was filed on May 27, 2021, and which is incorporated herein by reference.

### BACKGROUND

Neural networks are machine learning models that include one or more layers of nonlinear operations to predict an output for a received input. In addition to an input layer and an output layer, some neural networks include one or more hidden layers. The output of each hidden layer can be input to another hidden layer or the output layer of the neural network. Each layer of the neural network can generate a respective output from a received input according to values for one or more model parameters for the layer. The model parameters can be weights or biases that are determined through a training algorithm to cause the neural network to generate accurate output. A deep neural network includes multiple hidden layers. A shallow neural network has one or zero hidden layers.

Anomaly detection is the task of distinguishing anomalies from normal data, typically with use of a machine learning model. Anomaly detection is applied in a variety of different fields, such as in manufacturing to detect faults in manufactured products; in financial analysis to monitor financial transactions for potentially fraudulent activity; and in healthcare data analysis to identify diseases or other harmful conditions in a patient.

### BRIEF SUMMARY

Aspects of the disclosure provide for a machine learning model framework trained for anomaly detection in a self-supervised manner, using only unlabeled training data. Aspects of the disclosure also provide for methods for training the machine learning model framework to perform anomaly detection, using only unlabeled training data. A self-trained one-class classifier (STOC) as described herein can be trained to accurately perform anomaly detection on input data, while having been trained only on unlabeled training data. The STOC can receive raw training data or learned representations of unlabeled examples of both normal and anomalous data and refine the training data to generate a refined set of training data at least partially removing predicted examples of anomalies. The STOC, using the refined training data, can be trained to predict whether input data at inference is normal or anomalous.

An aspect of the disclosure provides for a system of one or more processors, the one or more processors configured to: receive unlabeled training data including a plurality of training examples; categorize, using a plurality of first machine learning models, each of the training examples as an anomalous training example or non-anomalous training example; generate a refined set of training data including the training examples categorized as non-anomalous training examples; and train a second machine learning model, using the refined set of training data, to receive input data and to generate output data indicating whether the input data is anomalous or non-anomalous.

Anomaly detection, or the distinguishing of the (usually less frequent) anomalies from normal samples, is a highly impactful problem with a wide range of applications, such as detecting faulty products using visual sensors in manufacturing, fraudulent behaviors at credit card transactions, and adversarial outcomes at intensive care units. Anomaly detection is often limited by the availability of labeled training data, limiting the ways in which systems trained for anomaly detection are developed and built. By refining the data first through categorization, aspects of the disclosure enable the feasible use of large unlabeled training data, versus approaches limited to labeled training examples. In turn, aspects of the disclosure provide for more accurate systems for performing anomaly detection, at least because the system provides for the use of the more plentifully available unlabeled training data.

Other aspects of the disclosure include methods, apparatus, and non-transitory computer readable storage media storing instructions for one or more computer programs that, when executed, cause one or more processors to perform the actions of the methods.

The foregoing and other aspects can include one or more of the following features, alone or in combination.

The unlabeled training data can include one or more anomalous training examples and one or more non-anomalous training examples.

The number of non-anomalous training examples can be greater than the number of anomalous training examples. The unlabeled training can include a mixture of anomalous and non-anomalous training examples without requiring a priori knowledge of which examples belong to which class. As a result, the use of the system as described in refining the data is more flexible, because the assumptions for the provided data are more relaxed versus other approaches in which the training examples are labeled. Further, the system may extend the boundary of anomaly detection applications where the labeling is expensive or not completely precise.

The method or operations performed by the one or more processors can further include training the plurality of first machine learning models using the refined set of training data. The method or operations performed by the one or more processors can further include performing additional iterations of: categorizing each of the training examples using the plurality of first machine learning models; and updating, based on the additional iterations, the refined set of training data.

Aspects of the disclosure provide for a semi-supervised system in which iterations of the refined training data are used to train and fine-tune one or more first machine learning models for improving the refinement of a training dataset to exclude anomalous training examples. This iterative approach can improve the accuracy of the system overall because the system is iteratively updated to adjust to the nuances of the anomalous training examples that can be unique to the training dataset. In contrast to approaches in which training data is categorized for identifying anomalous/non-anomalous training examples in one iteration, the iterative approach as described herein provides the opportunity to correct the system to refine the anomalous training examples more accurately from the non-anomalous training examples.

The method or operations performed by the one or more processors can further include training a third machine learning model using the refined set of training data, wherein the third machine learning model is trained to receive training examples and to generate one or more respective feature values for each of the received training examples; and when categorizing the unlabeled training data using the plurality of first machine learning models including processing, using the plurality of first machine learning models, respective one or more feature values for each training example of the unlabeled training data, wherein the respective one or more feature values are generated using the third machine learning model.

The method or operations performed by the one or more processors can further include performing additional iterations of training the third machine learning model using the refined set of training data.

The third machine learning model can be a representation learning model, trained to generate feature values from the input training examples. Aspects of the disclosure provide for categorizing training examples based on the learned representation of features of the training examples, generated by the representation learning model. Training on representations instead of raw inputs alone can further improve the accuracy of the resulting data refinement.

The plurality of first machine learning models and the second machine learning model can be one-class classifiers.

The system described herein is agnostic to different machine learning model architectures, meaning that it can be implemented in a variety of different anomaly detection processing pipelines, without loss of generality. This flexibility in model architecture further expands the domain of possible applications, in addition to the flexibility of the system in refining different training datasets. In turn, a system trained according to aspects of the disclosure can be more easily adapted to certain use cases and technical restrictions, which can improve performance over approaches in which data refinement is limited to certain model architectures or use cases.

The method or operations performed by the one or more processors can further include training each of the first machine learning models using a respective subset of the unlabeled training data; processing a first training example of the unlabeled training data through each of the plurality of first machine learning models to generate a plurality of first scores corresponding to respective probabilities that the first training example is non-anomalous or anomalous; determining that at least one first score does not meet one or more thresholds; and in response to determining that the at least one first score does not the meet one or more thresholds, excluding the first training example from the unlabeled training data.

The one or more thresholds can be based on a predetermined percentile value of a distribution of scores corresponding to respective probabilities that training examples in the unlabeled training data are non-anomalous or anomalous. The one or more thresholds can include a plurality of thresholds, each threshold based on the predetermined percentile value of a respective distribution of scores generated from training examples processed by a respective first machine learning model of the plurality of first machine learning models.

The method or operations performed by the one or more processors can include generating the one or more thresholds based on minimizing, over one or more iterations of an optimization process, respective intra-class variances among anomalous and non-anomalous training examples in the training data.

Providing per-machine learning model thresholds allows for accounting of differences in model processing and tolerances for categorizing anomalous from non-anomalous training examples, preventing one model from overwriting decisions of the rest of the ensemble. As described in more detail below, the system can generate a pseudo label for each example, representing a consensus of the plurality of models in determining whether or not the example is anomalous or not.

The method or operations performed by the one or more processors can include receiving the input data and processing the input data using the second machine learning model to generate the output data indicating whether the input data is anomalous or non-anomalous.

The method or operations performed by the one or more processors can further include sending the output data for display on a display device coupled to the one or more processors.

### BRIEF DESCRIPTION OF THE DRAWINGS

FIG. 1 is a block diagram of an example self-trained one-class classifier (STOC), according to aspects of the disclosure.

FIG. 2 is a block diagram of an example STOC including a representation learning model.

FIG. 3 is a flowchart of an example process for training a STOC using unlabeled training data.

FIG. 4 is a flowchart of an example process for refining unlabeled training data, according to aspects of the disclosure.

FIG. 5 is a flowchart of an example process for training a STOC with a representation learning model.

FIG. 6 is a block diagram of an example computing environment implementing an example STOC.

### DETAILED DESCRIPTION

### Overview:

Aspects of the disclosure provide for a machine learning model framework of one-class classifiers trained for anomaly detection in a self-supervised manner, using only unlabeled training data. Anomaly detection refers to the process of distinguishing anomalous data from non-anomalous data in a dataset. Anomalous data differs from non-anomalous, “normal” data, for example because the anomalous data represents statistical outliers, contains noise, or has characteristics that differ from non-anomalous data according to a decision boundary, which can be learned or predetermined. Aspects of the disclosure provide for training a one-class classifier on unlabeled training data, without prior knowledge of the presence, absence, or specific distribution of anomalous training examples in the training data.

A one-class classifier (OCC) is a type of machine learning model trained to predict whether input data belongs to a certain class or not. OCCs can be trained on training data indicative of the class an OCC is being trained to predict. OCCs can be trained on training data that includes labeled training examples. For instance, an OCC for anomaly detection may be trained on training data that includes examples that are labeled as being anomalous or non-anomalous. One problem with this approach is that labeled data can be expensive and time-consuming to produce. Further, anomalous data by its nature occurs less frequently than non-anomalous data, and anomalies can manifest in different and often unpredictable ways, adding to the difficulty of generating labeled training data. In some cases, the lack of available data makes training a model to perform some tasks infeasible, if not practically impossible. While this problem can be offset with training data with only a limited number of labeled training examples, current approaches continue to rely on the presence of at least some labeled training data for training models for anomaly detection, the accuracy of which hinges on the availability of training on such labeled data.

While OCCs may be trained on unlabeled training data that includes training data that includes only non-anomalous examples, in practice providing uniform non-anomalous training data to train an accurate classifier is difficult, at least because of the possibility of anomalous training examples being included inadvertently. Further, training data assumed to include only non-anomalous training examples can in reality include some anomalous data, which can negatively affect the accuracy of OCCs trained with training data under this false assumption. Even a small anomaly ratio of anomalous to non-anomalous training examples, e.g., 2%, can significantly impact performance for models trained for one-class classification. OCC performance degrades further when trained on data with even higher anomaly ratios.

A self-trained one-class classifier (“STOC”) as described herein is a machine learning framework for training a model, such as a one-class classifier, to perform anomaly detection. The training can be performed in a self-supervised manner, without labeled training data and without assuming the presence or distribution of anomalous training examples in provided training data, beyond a basic assumption that the training data includes more non-anomalous training examples than anomalous training examples.

The STOC can include an ensemble of individual OCCs, each trained and updated according to received training data after one or more iterations of data refinement. The STOC can refine the training data to categorize training examples and exclude anomalous training examples identified from the individual outputs of the OCCs. A refined set of training data (“refined training data”) excluding the identified anomalous training examples can be passed back through the OCCs for additional training After a final iteration of data refinement, the STOC trains an output classifier model to predict a final classification of input data as non-anomalous or anomalous.

Refining training data as described herein can enable the training data to be used to train any of a variety of models for performing one-class classification and anomaly detection, at least because the aforementioned performance drop from training on mixed unlabeled anomalous and non-anomalous can be reduced or eliminated from the training data. Manually labeling training examples is not required, and the STOC as described herein is robust in refining training data of any of a variety of anomaly ratios, e.g., 0%-20% or higher, and can refine data where at least the number of anomalous training examples is less than the number of non-anomalous training examples. Any of a variety of OCCs can be trained using the STOC, as described herein.

In addition, the STOC can include a representation learning model for generating a feature representation of one or more feature values for training examples in the training data. Like the individual OCCs, the representation learning model can be trained and updated using the training data after one or more iterations of data refinement. The representation learning model can be trained to be more accurate in generating feature values for each training example, which the individual OCCs can be configured to receive and process to generate more accurate classifications of their own.

The process of data refinement and updating the various models implemented as part of the STOC can help to improve the accuracy of the output classifier model, which itself can be any of a variety of different OCCs. For example, an OCC implemented by the STOC can include a one-class support vector machine (OC-SVM), a kernel density estimation model (KDE), a Gaussian density estimation model (GDE), or an auto-encoder based model. In different examples, an OCC can be a shallow or deep neural network, e.g., having zero or more hidden layers, in addition to an input layer and an output layer. OCCs implemented by the STOC can be implemented using any technique for geometric transformation, outlier exposure, or support vector data description (SVDD). Further, the presence of unlabeled training examples does not affect the accuracy of the STOC over other approaches, at least because the STOC can iteratively remove anomalous training examples and learn from the refined training data. Rather than perform worse with more anomalous training examples as compared with previous approaches, the STOC can perform better than one-class classifiers trained on data without data refinement as described herein, at least because of the refinement of the training data and the improved representation learning and classification as a result of the refinement.

Once trained, the STOC can be applied in any setting in which anomaly detection can help in identifying potential risks or danger identifiable from data representing such things as the behavior or state of a person, system, or environment. Anomaly detection is improved at least because the refined training data generated according to aspects of the disclosure can provide for more accurately trained models, without the additional computational effort of providing labeled training examples.

As an example, the input to the STOC can be in the form of images, videos, audio, or a combination of audio and video. The input can be taken from sensors at a manufacturing site in which different parts are machined or manufactured, for example for use in construction or in vehicle assembly. The STOC can receive video or images of the parts on the assembly line, and identify anomalous parts, e.g., parts with defects or that are otherwise different from non-anomalous parts being manufactured. The anomalous parts can be flagged and set aside for further inspection, or discarded automatically, as examples.

As another example, the input to the STOC can be one or more data files corresponding to a particular format, e.g., HTML files, tables, charts, logs, word processing documents, or formatted metadata obtained from other types of data, such as metadata for image files. In an example in which the STOC processes tables of records indicating various credit card transactions, the STOC can identify anomalous transactions, which can be flagged to be investigated further as potentially related to fraudulent activity.

Other types of input documents can be data relating to characteristics of a network of interconnected devices. These input documents can include network activity logs, as well as records concerning access privileges for different computing devices to access different sources of potentially sensitive data across a monitored network. The STOC can be trained for processing these and other types of documents for predicting anomalous traffic potentially indicative of on-going and future security breaches to the network.

As yet another example, the STOC can be trained to analyze patient data over a variety of different modalities, e.g., images, videos, and textual, numerical, and/or categorical information, to identify anomalous patterns, and/or to identify anomalous regions in received video or images. The detected anomalies can be flagged automatically for review by a healthcare provider, to aid in preparing a diagnostic or treatment plan based on the detected anomalies and other information.

As yet another example, the STOC can be trained to process images, audio, and/or video of a manufacturing line or other industrial process, to identify anomalies, for example in how the process is being performed, and/or in the products being generated according to the process. In some instances, the STOC is implemented as part of an industrial processing monitoring system for receiving input data and generating indications and/or reports of detected anomalous occurrences from the received input data.

As yet another example, the STOC can be trained to detect improper usage of cloud computing resources on a resource allocation system. For example, a cloud computing platform may be configured to allocate computing resources, e.g., compute time or storage, to a variety of users. A system trained according to aspects of the disclosures can identify anomalous usage of allocated computing resources, which for example may be indicative of impermissible activity, such as abuse of resources, e.g., for malicious activity such as network intrusion.

As yet another example, the STOC can be trained to process transaction data, e.g., financial transactions, to identify anomalies indicative of fraudulent behavior. Fraudulent behavior can include unapproved credit card transactions, for example by unauthorized users, or money-laundering activity. These and other fraudulent activities undermine the technical security provided by a system managing the subject transactions.

The STOC can also be trained on time-series data, which can be present in a variety of different modalities, such as tabular data, image data, audio data, etc. Time-series data may appear in anomaly detection applications, such as those described above. In addition to identifying anomalous data by virtue of its relation to other data points in a dataset, the STOC can identify anomalous data using an additional temporal dimension, for example to identify patterns of anomalous or non-anomalous data patterns depending on its occurrence during a time period, e.g., hourly, daily, weekly, etc. In the examples provided above, the STOC is able to detect anomalies for the type of data used in training, after refining the training data to omit anomalous training examples.

### Example Systems

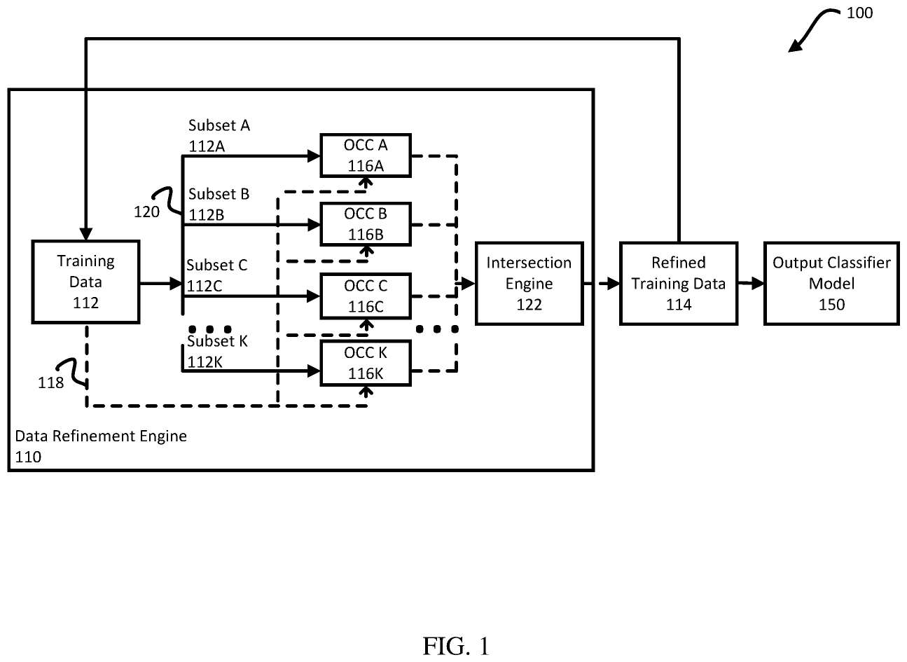

FIG. 1 is a block diagram of an example self-trained one-class classifier 100 (STOC), according to aspects of the disclosure. The STOC 100 includes a data refinement engine 110 and an output classifier model 150. The data refinement engine 110 is configured to receive training data 112, and to generate refined training data 114. Training data 112 can include one or more training examples that can be provided according to a variety of different sources and in a variety of different formats. Example formats for the training data 112 include images, audio clips, text, video clips, and data structured according to any one of a variety of different data structures, including tables, graphs, logs, and transcripts. The training data 112 can include multiple unlabeled training examples, such as image frames, portions of audio clips, text, records from a table or log, or any other data that can be processed for anomaly detection.

The training examples of the training data 112 are unlabeled and can include a combination of anomalous and non-anomalous examples. A training example or input data is considered anomalous when characteristics of the example or data are different from other examples or input data by some decision boundary. The STOC 100 as described herein, as part of classifying whether input data is anomalous or not, learns a decision boundary by training on the training data 112. Anomalous data can be, for example, statistical outliers relative to other received data, including noise.

The training data 112 is unlabeled, meaning that, unlike in supervised or semi-supervised settings in which at least some training examples are anomalous or non-anomalous, the training data 112 includes no labels for its training examples. The training data 112 is assumed to include fewer anomalous training examples than non-anomalous training examples, and for example can include no anomalous training examples at all. The data refinement engine 110 as described herein is configured to refine the training data 112 to categorize training examples as anomalous or anon-anomalous, and exclude anomalous training examples in a generated refined set of training 114, if any are present in the training data 112.

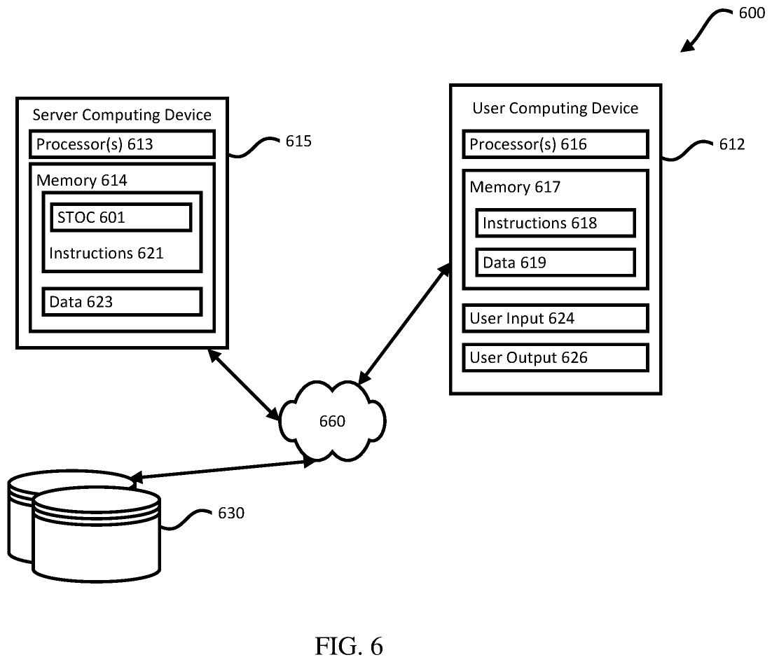

The training data 112 itself can be received by the data refinement engine 110 from a variety of different sources. For example, the STOC 100 can be implemented on one or more devices in communication with other devices over a network, as described in more detail with reference to FIG. 6. The training data 112 can be received by other devices on the network, or by one or more devices implementing the STOC 100. The training data 112 can be sent from device-to-device over some interface, for example a user interface configured for sending training data to the STOC 100.

The data refinement engine 110 can perform one or more iterations of data refinement on the training data 112 to generate refined training data 114. Refined training data 114 is training data which has been processed by categorizing training examples as anomalous or non-anomalous and excluding one or more training examples from the training data 112 categorized by the data refinement engine 110 as being anomalous. The remaining training examples become part of the refined training data 114.

Refined training data 114 can be provided as input to the data refinement engine 110 for further refining, e.g., additional categorizing and generating further refined training data 114. The refined training data 114 is used to train various machine learning models implemented as part of the STOC 100, including OCCs 116A-K, and the output classifier model 150.

After the final iteration of data refinement by the data refinement engine 110, the STOC 100 trains the output classifier model 150 using the refined training data 114. The final iteration of data refinement can occur in response to some predetermined stopping criteria. For example, the stopping criteria can be a preset number of iterations, a minimum number of excluded training examples from an iteration of refinement, or a minimum size of the training data after refinement.

The output classifier model 150 can be trained according to any of a variety of different approaches for unsupervised learning using unlabeled training data and according to one or more model training criteria. In some examples, the model training criteria can be a maximum or minimum number of iterations of an unsupervised training process, convergence to a target accuracy within some threshold, and/or a certain amount of time. The output classifier model 150 can be any kind of machine learning model suitable for one-class classification, e.g., any kind of one-class classifier, such as an OC-SVM, a KDE, a GDE, an auto-encoder based model, or implemented according to any technique for one-class classification with deep or shallow models, for example as described herein with reference to the OCCs 116A-K and OCCs implemented by the STOC 100. As part of training, the output classifier model 150 learns a decision boundary for predicting whether a training example is anomalous or non-anomalous.

The specific output of the output classifier model 150 can be a binary label, e.g., anomalous or non-anomalous, or a probability or score corresponding to a probability that the input data belongs to the class of non-anomalous data or not. In some examples, the output classifier model 150 can generate separate outputs for anomalous or non-anomalous predictions, while in other examples the output classifier model 150 only generates output when the model 150 predicts the input data to belong to a class of anomalous data, or a class of non-anomalous data.

After generating the output classification, the STOC 100 can send the data for further processing as part of a processing pipeline for receiving input data and performing anomaly detection on that input data. For example, in response to predicting an anomaly, the STOC 100 can pass data corresponding to the anomaly to one or more processors configured to perform some action in response to receiving anomalous data. The anomalous data can be flagged for further review, for example manual review or by the one or more processors automatically. The anomalous data may be logged and saved in memory for review at a later date. In other examples, the anomalous data can be further processed for classifying the type of anomaly indicated by the data, and/or to assess a threat or vulnerability to a system, one or more entities, and/or to a process potentially affected by the detected anomaly.

Returning to the data refinement engine 110, the engine 110 can define a training pipeline 120 (shown as solid arrows within the engine 110) and an inference pipeline 118 (shown as dashed arrows within the engine 110). In the training pipeline 120, subsets 112A-K of the training data 112 are sent to the OCCs 116A-K. In some examples, the subsets 112A-K can be evenly divided and randomly sampled from the training data 112. The data refinement engine 110 is configured to train each of the OCCs 116A-K using respective subsets 112A-K. For example, and as illustrated in FIG. 1, model A 116A is trained using subset 112A, model B 116B is trained using 112B, model C 116C is trained using 112C, and model K 116K is trained using 112K. OCCs 116A-K can be a combination of any of a variety of different types of OCCs, such as OC-SVMs, KDEs, GDEs, auto-encoder based models, or implemented according to any technique for one-class classification with deep or shallow models, as examples.

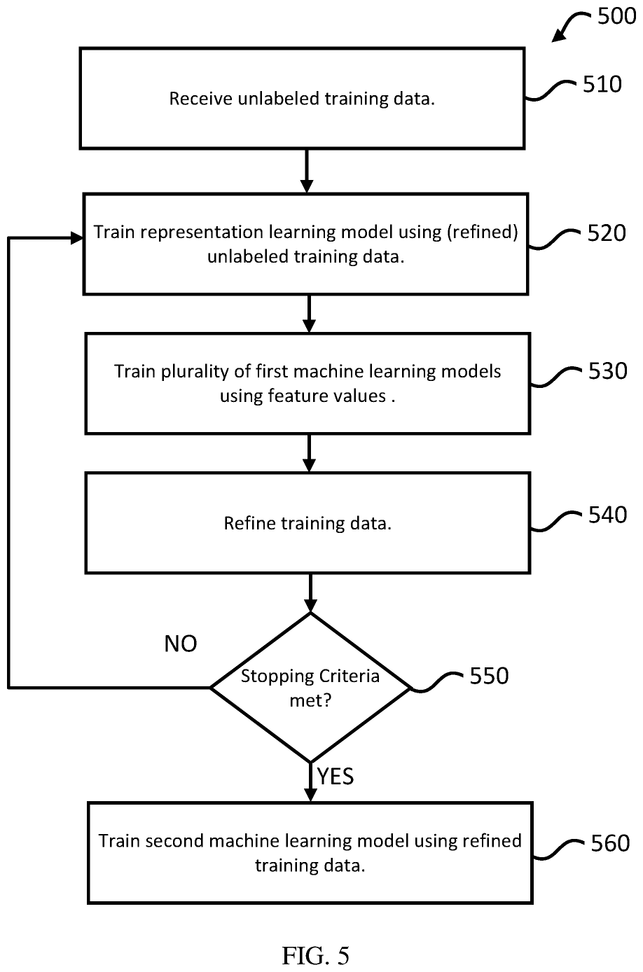

The data refinement engine 110 can train each OCC 116A-K according to one or more model training criteria, for example model training criteria used to train the output classifier model 150. As described herein, the data refinement engine 110 can train or retrain the OCCs 116A-K with subsets of the refined training data 112. In the first iteration of data refinement as described herein with respect to FIG. 5, the training data 112 can be the initial training data received by the STOC 100. Each OCC 116A-K can be trained similarly to the output classifier model 150, e.g., according to an unsupervised learning approach with the refined training data, to predict whether input data belongs to a class defining anomalous or non-anomalous data.

The OCCs 116A-K can be retrained to update model parameter values for the OCCs 116A-K after each iteration of data refinement, after a predetermined number of iterations, e.g., after every 5 or 50 iterations of data refinement, or trained according to some predetermined schedule. In one example training schedule, the OCCs 116A-K are trained after the 1^{st} iteration, 2^{nd} iteration, 5^{th} iteration, 10^{th} iteration, 20^{th} iteration, 50^{th} iteration, 100^{th} iteration, 500^{th} iteration, and then again every 500 iterations until meeting the stopping criteria.

In the inference pipeline 118, the data refinement engine 110 processes each training example in the training data 112 through each OCC 116A-K to generate a number of individual predictions by the OCCs 116A-K. The individual predictions can be represented as scores corresponding to whether an OCC has predicted the training example to be anomalous or not, with some probability. An example formulation of a score can be 1 minus the output probability of an OCC. A score closer to 0 corresponds to a higher probability of the OCC having detected an anomaly, while a score closer to 1 corresponds to a higher probability of the OCC having not detected an anomaly.

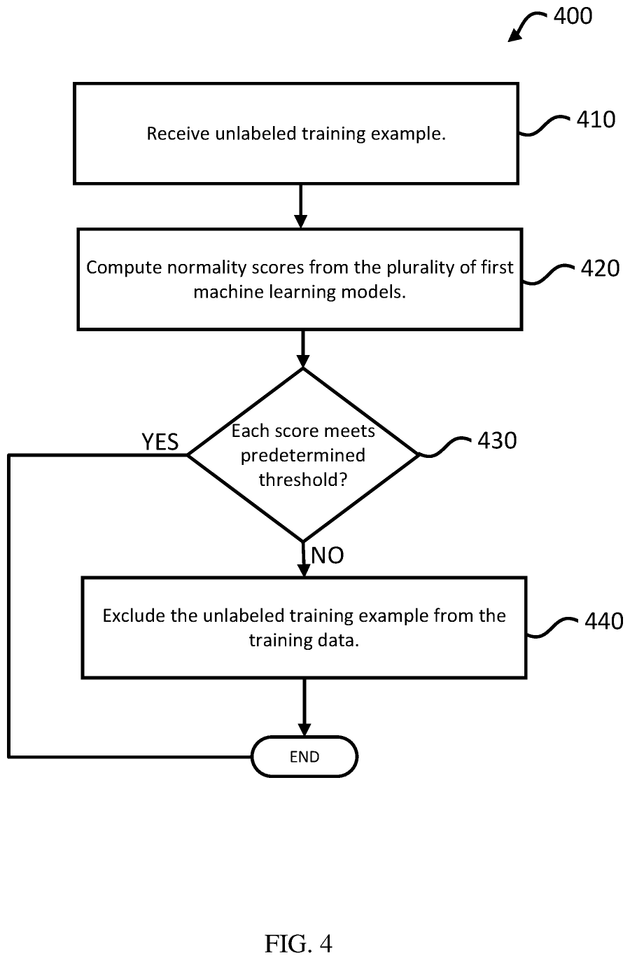

An intersection engine 122 can receive each individual prediction and compare the individual predictions to one or more thresholds. A threshold can be model-specific and be based on a predetermined percentile value of a distribution of scores generated by the model for each training example. Example percentile values and calculation of the one or more thresholds are described herein with reference to FIG. 4. An intersection engine 122 can receive each individual prediction from the OCCs 116A-K and generate a pseudo label for the training example. For example, the pseudo label can indicate that the training example is anomalous if any individual prediction does not meet a respective threshold. Based on the pseudo label for the training example, the intersection engine 122 can be configured to categorize training examples as anomalous or non-anomalous based on the pseudo labels, and exclude the training example if the pseudo label indicates that the training example is anomalous. Each training example in the training data 112 is processed through the inference pipeline 118 to generate the refined training data 114.

The use of multiple one-class classifiers can account for variation or potential inaccuracy over using a single model. The resulting ensemble can be more robust than a single model in generating pseudo labels for categorizing training examples, at least because the risk of false positive or false negative is reduced through the consensus of multiple models.

After an iteration of data refinement, e.g., training the OCCs 116A-K on the current training data 112 using the training pipeline 120, and processing each training example on the current training data 112 through each OCC 116A-K and the intersection engine 122, the refined training data 114 can be looped back through the training pipeline 120 and the inference pipeline 118 again for a subsequent iteration, if the stopping criteria have not been met. In this way, the STOC 100 facilitates a self-supervised process of training the OCCs 116A-K, at least because the OCCs 116A-K can be retrained on the refined training data 114 generated using the previously obtained pseudo labels.

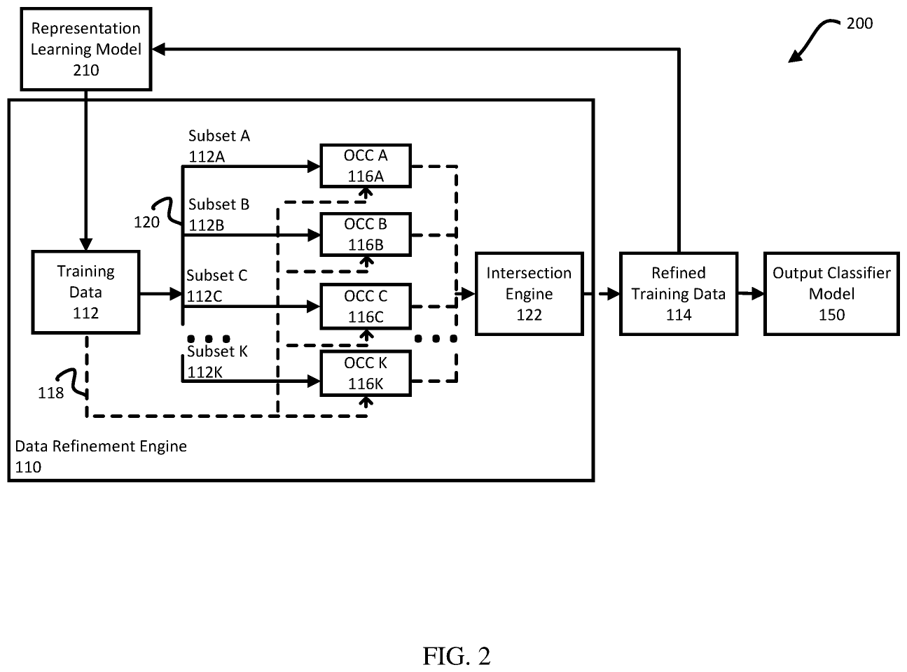

FIG. 2 is a block diagram of an example STOC 200 including a representation learning model 210. The STOC 200 can include the same or similar components as the STOC 100, e.g., the data refinement engine 110 and the output classifier model 150. The representation learning model 210 can be trained to generate, from the refined training data 114, one or more feature values for each training example in the refined training data 114. A feature value can be a quantifiable measure of some characteristic, or feature, or the training example. Feature values can be represented in a variety of different formats, for example as text values, numerical values, or categorical values. The representation learning model 210 can then augment the refined training data 114 with predicted feature values, which can be received for training/processing by the OCCs 116A-K and the output classifier model 150. Example representation learning models can include rotation prediction networks, denoising autoencoders, and distribution-augmented contrastive learning approaches.

By first learning a representation of one or more feature values for each training example, the representation learning model 210 can improve model accuracy by the OCCs 116A-K processing the training data augmented with the learned feature values. The representation learning model 210 itself can be trained according to a self-supervised approach, similar to the OCCs 116A-K, using the refined training data 114 and model training criteria, e.g., model training criteria used to train the OCCs 116A-K. The representation learning model 210, like the OCCs 116A-K, can be retrained with the refined training data 114 after each iteration of data refinement, or after a predetermined number of iterations or predetermined schedule. This approach can prevent the degeneracy of the OCCs 116A-K, especially if the OCCs 116A-K are implemented as deep neural networks including one or more hidden layers.

### Example Methods

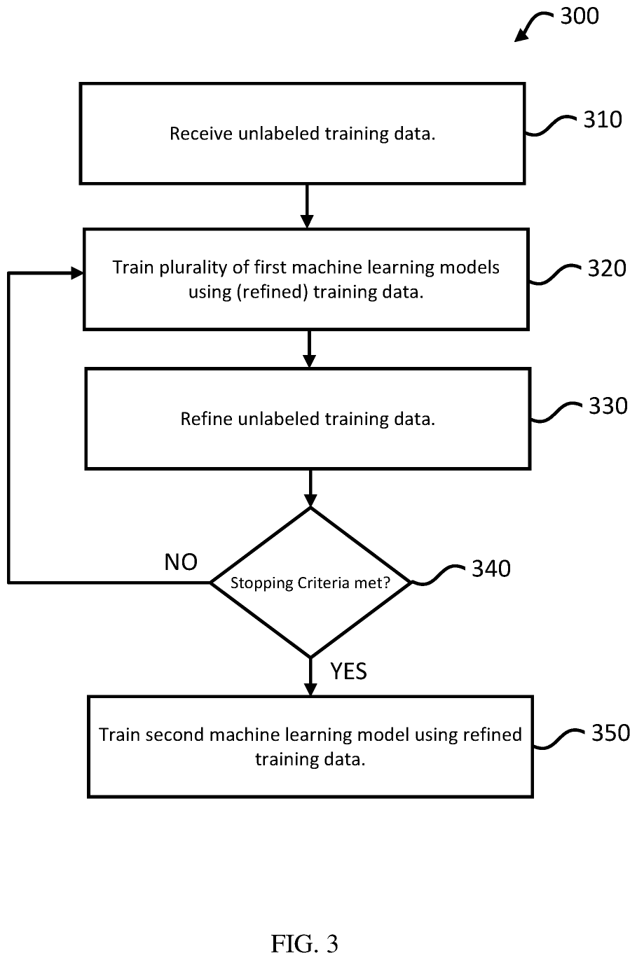

FIG. 3 is a flowchart of an example process 300 for training a STOC using unlabeled training data.

The STOC receives unlabeled training data, according to block 310. The STOC trains a plurality of first machine learning models using (refined) training data, according to block 320. The first machine learning models can be the OCCs 116A-K as described herein with reference to FIGS. 1-2. In the first iteration of data refinement, the training data is the initial training data received, according to block 310.

The STOC refines the unlabeled training data, according to block 330. As described herein with reference to FIGS. 1-2 and as described in more detail with reference to FIG. 5, the STOC refines the unlabeled training data by categorizing the training examples as anomalous or non-anomalous, and generating the refined training data by those examples that are predicted to be anomalous.

The STOC determines whether stopping criteria to stop training the STOC have been met, according to decision block 340. As described herein with reference to FIGS. 1-2, the STOC can be configured with predetermined stopping criteria to stop the data refinement after performing one or more iterations.

If the STOC determines that the stopping criteria have been met (“YES”), then the STOC trains a second machine learning model using the refined training data, according to block 350. The second machine learning model can be the output classifier model 150 as described herein with reference to FIGS. 1-2.

If the STOC determines that the stopping criteria have not been met (“NO”), the STOC repeats the operations according to blocks 320, 330, and decision block 340. In examples in which the first machine learning models are not trained after each iteration of data refinement, the STOC is configured to skip training the plurality of first machine learning models according to block 320 based on a predetermined number of iterations or schedule as described herein.

FIG. 4 is a flowchart of an example process 400 for refining unlabeled training data, according to aspects of the disclosure. The process 400 is described as performed for a single training example. The STOC is configured to perform the process 400 for at least a portion of the training examples in the training set, e.g., reserved for testing. In other examples, the STOC performs the process 400 for every training example in the training data.

A STOC receives an unlabeled training example, according to block 410.

The STOC computes normality scores from the plurality of first machine learning models, according to block 420.

The STOC determines whether each normality score meets a threshold, according to decision block 430. If the STOC determines that each normality score meets the threshold (“YES”), then the process 400 ends.

The pseudo label ŷₗ for a training example xᵢ can be represented as follows:

$${\hat{y}}_{l} = 1 - {\prod }_{k = 1}^{K} ( {f}_{k} ( {x}_{i} ) \geq {η}_{k} ) \qquad ( 1 )$$

In (1), 1(⋅) is an indicator function that outputs 1 for true input, and 0 for false input. fₖ(xᵢ) is the output score of a first machine learning model k, e.g., OCCK as shown in FIG. 1. The output score of each model k is compared against a respective threshold ηₖ. If the individual prediction fₖ (xᵢ) is greater than the threshold ηₖ, then 1(fₖ(xᵢ)≥ηₖ) outputs to 0, otherwise 1.

Each 1(fₖ(⋅)) is multiplied together, with the product being 0 if any individual 1(fₖ(⋅)) is 0, and 1 otherwise. Accordingly, the pseudo label ŷₗ is 1 if any 1(fₖ(⋅)) is 0, corresponding to at least one model predicting the training example to be anomalous. The pseudo label ŷₗ is 0 if every individual 1(fₖ((⋅) is 1, corresponding to agreement across each first machine learning model that the training example is non-anomalous. In this way, training examples are marked as anomalous unless there is entire agreement across each model in predicting that the training example is non-anomalous, to increase the chances that truly anomalous training examples are excluded from the training data. In some examples, instead of a multiplication of multiple indicator functions for each model k, the pseudo label can be represented as a logical conjunction, e.g., logical AND, of the result of each indicator function. In some examples, the STOC can compute the pseudo label to have a lower requirement from individual predictions from each first machine learning model. For example, the pseudo label can indicate that a training example is non-anomalous

The threshold for a model is calculated as a certain percentile threshold γ of the score distribution of the model k for all of the scores output by the model k for the training examples in the training data in the current iteration. The threshold ηₖ can be represented as:

$$η such that [ \frac{1}{N} {\sum }_{i = 1}^{N} ( {f}_{k} ( {x}_{i} ) > η ] \geq γ \qquad ( 2 )$$

The percentile threshold γ can be set as a hyperparameter. If the percentile threshold is larger, then more examples are predicted to be anomalous, which can result in more anomalous and training examples being excluded overall. If the percentile threshold is smaller, the refined training data may still include anomalous training examples, but provide more coverage in non-anomalous training examples in the refined training data. The percentile threshold γ can be set as a function of the true anomaly ratio in the training data if the ratio is known. For example, the percentile threshold γ can be set to a value between the true anomaly ratio and twice the true anomaly ratio, as an example. If the true anomaly ratio is not known, or if the ratio is zero, e.g., because there are no anomalous examples in the training data, then the percentile threshold γ can be a predetermined value, e.g., 0.1 or 0.5.

In some examples, instead of receiving the percentile threshold γ, the STOC can generate or receive a percentile threshold γ from an identified or estimated threshold dividing anomalous and non-anomalous examples in training data. By identifying or estimating the anomaly ratio, the STOC can refine unlabeled training data even when a true anomaly ratio is not known or provided to the STOC. The STOC can generate the percentile threshold based on minimizing, over one or more iterations of an optimization process, respective intra-class variances among anomalous and non-anomalous training examples in the training data.

To identify or estimate the threshold, the STOC can perform an optimization process to reduce intra-class variance between anomalous and non-anomalous training examples in training data. Reducing the intra-class variance increases the chance of clustering anomalous examples with other anomalous examples and non-anomalous examples with other non-anomalous examples. The intra-class variances can be represented as a weighted sum of variances of the two classes: anomalous and non-anomalous. During an optimization process to reduce the intra-class variance, the STOC can search for a threshold that minimizes the sum of the variances of each class. One example process that can be used is Otsu's Method.

The STOC can perform one or more iterations of Otsu's Method or another optimization process until meeting one or more stopping criteria. Stopping criteria for performing an optimization process for identifying a threshold can include a predetermined maximum number of iterations, a minimum change in the value of the threshold value between iterations, etc.

The STOC 200 can perform Otsu's Method or another process to identify the threshold between normal and anomalous samples, using that threshold to select the corresponding percentile threshold γ. For example, given the normality scores {sᵢ}₍ᵢ₌₁₎^{N} from N training examples, the STOC searches for a threshold η that minimizes the weighted sum of the variance between the two classes of the training data. If the variances of the two classes are denoted as σ₀(η) and σ₁(η), respectively, and the weights to the variances of the two classes are denoted as

$${w}_{0} ( η ) = {\sum }_{i = 1}^{N} \frac{( {s}_{i} < η )}{N} and {w}_{0} ( η ) = {\sum }_{i = 1}^{N} \frac{( {s}_{i} \geq η )}{N} ,$$

then the optimal threshold (η*) may be determined as:

η*=w₀(η)×σ₀(η)+w₁(η)×σ₁(η)

The STOC can use a function of the identified or estimated threshold η* , e.g., up to two times the identified or estimated threshold, as a hyperparameter percentile threshold γ, as described herein.

In examples in which the STOC includes a representation learning model, then each model processes feature values generated by the data refinement model in addition to or as an alternative to the raw training example. The representation learning model can be represented by the function g(⋅), and generating the pseudo label can be represented as:

$$\hat{y} = 1 - {\prod }_{k = 1}^{K} ( {f}_{k} ( g ( {x}_{i} ) ) \geq {η}_{k} \qquad ( 3 )$$

In some examples, if the STOC does not include a representation learning model, generating the pseudo label can be represented according to formula (3), with g(⋅) being an identity function.

The number of OCCs 116A-K can be predetermined as a hyperparameter for the STOC 100. The exact number of models can vary from implementation-to-implementation, depending for example on hardware constraints of hardware implementing the STOC 100, and/or the nature of the specific task of anomaly detection the STOC 100 is trained to perform. The number of OCCs 116A-K can also be determined as a trade-off between individual OCC performance and robustness of the pseudo label against randomness in the output of the individual OCCs 116A-K. For example, when the number of OCCs 116A-K is larger, the odds of an anomalous training sample being predicted as non-anomalous is lower, since if any one OCC predicts that the example is anomalous, the pseudo label will also reflect that the example is anomalous. However, a smaller number of OCCs 116A-K allows more training data to be provided in each subset 112A-K, which can improve the performance of each OCC through training overall. Example numbers of OCCs 116A-K can be between two and ten, although in general any number of OCCs 116A-K can be used from implementation-to-implementation.

If the STOC determines that at least one normality score does not meet the threshold (“NO”), then the STOC exclude the training example from the training data, according to block 440. The training example is not included in the refined training data. In some examples, after excluding the training example, the STOC can save the training example in memory to be reviewed at a later time. The training example can be manually reviewed, for example, for additional insight into the nature of anomalous data in the training data, which can drive subsequent modifications to the training data and/or hyperparameters of the STOC, such as the percentile threshold and/or the number of individual OCCs in the data refinement engine.

FIG. 5 is a flowchart of an example process 500 for training a STOC with a representation learning model.

A STOC receives unlabeled training data, according to block 510. For example, the STOC receives unlabeled training as described herein with reference to FIG. 1, and with reference to block 310 of FIG. 3.

The STOC trains a representation learning model using (refined) unlabeled training data, according to block 520. The representation learning model can be trained initially on the training data before the first iteration of data refinement or be trained initially after the first iteration of data refinement, according to some examples.

The STOC trains a plurality of first machine learning models using (refined) training data, according to block 530. For example, the STOC trains the plurality of first machine learning models using (refined) training data as described herein with reference to FIG. 1, and with reference to block 320 of FIG. 3.

The STOC refines the unlabeled training data, according to block 540. For example, the STOC can perform the process 400 for each training example in the training data, to categorize the training examples using generated pseudo labels, and to exclude training examples from the data predicted to be anomalous.

The STOC determines whether stopping criteria to stop training the STOC have been met, according to decision block 550. The stopping criteria can be the same or similar to the stopping criteria as described with reference to decision block 340 of FIG. 3.

If the STOC determines that the stopping criteria have been met (“YES”), then the STOC trains a second machine learning model using the refined training data, according to block 560. The second machine learning model can be the output classifier model 150 of FIGS. 1-2, and can be trained as described herein according to FIG. 1 and block 350 of FIG. 3. If the STOC determines that the stopping criteria have not been met (“NO”), the STOC repeat the operations according to blocks 520, 530, 540, and decision block 550. As described herein with reference to FIG. 3, if the STOC is configured not to retrain the first machine learning models or the second machine learning models after each iteration of data refinement, the STOC the training according to blocks 520 or 530 for a predetermined number of iterations and/or a predetermined schedule.

### Example Computing Environments

FIG. 6 is a block diagram of an example computing environment 600 implementing an example STOC 601. For example, the STOC 601 can be the STOC 100 or the STOC 200, as described herein with reference to FIGS. 1-2. The STOC 601 can be implemented on one or more devices having one or more processors in one or more locations, such as in server computing device 615. User computing device 612 and the server computing device 615 can be communicatively coupled to one or more storage devices 630 over a network 660. The storage device(s) 630 can be a combination of volatile and non-volatile memory, and can be at the same or different physical locations than the computing devices 612, 615. For example, the storage device(s) 630 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 615 can include one or more processors 613 and memory 614. The memory 614 can store information accessible by the processor(s) 613, including instructions 621 that can be executed by the processor(s) 613. The memory 614 can also include data 623 that can be retrieved, manipulated, or stored by the processor(s) 613. The memory 614 can be a type of non-transitory computer readable medium capable of storing information accessible by the processor(s) 613, such as volatile and non-volatile memory. The processor(s) 613 can include one or more central processing units (CPUs), graphic processing units (GPUs), field-programmable gate arrays (FPGAs), and/or application-specific integrated circuits (ASICs), such as tensor processing units (TPUs).

The instructions 621 can include one or more instructions that, when executed by the processor(s) 613, cause the one or more processors to perform actions defined by the instructions. The instructions 621 can be stored in object code format for direct processing by the processor(s) 613, or in other formats including interpretable scripts or collections of independent source code modules that are interpreted on demand or compiled in advance. The instructions 621 can include instructions for implementing the processes 300-500 consistent with aspects of this disclosure. The processes 300-500 can be executed using the processor(s) 613, and/or using other processors remotely located from the server computing device 615.

The data 623 can be retrieved, stored, or modified by the processor(s) 613 in accordance with the instructions 621. The data 623 can be stored in computer registers, in a relational or non-relational database as a table having a plurality of different fields and records, or as JSON, YAML, proto, or XML documents. The data 623 can also be formatted in a computer-readable format such as, but not limited to, binary values, ASCII, or Unicode. Moreover, the data 623 can include information sufficient to identify relevant information, such as numbers, descriptive text, proprietary codes, pointers, references to data stored in other memories, including other network locations, or information that is used by a function to calculate relevant data.

The user computing device 612 can also be configured in a similar way to the server computing device 615, with one or more processors 616, memory 617, instructions 618, and data 619. The user computing device 612 can also include a user output 626, and a user input 624. The user input 624 can include any appropriate mechanism or technique for receiving input from a user, such as keyboard, mouse, mechanical actuators, soft actuators, touchscreens, microphones, and sensors.

The server computing device 615 can be configured to transmit data to the user computing device 612, and the user computing device 612 can be configured to display at least a portion of the received data on a display implemented as part of the user output 626. The user output 626 can also be used for displaying an interface between the user computing device 612 and the server computing device 615. The user output 626 can alternatively or additionally include one or more speakers, transducers, or other audio outputs, a haptic interface or other tactile feedback that provides non-visual and non-audible information to the platform user of the user computing device 612.

Although FIG. 6 illustrates the processors 613, 616 and the memories 614, 617 as being within the computing devices 615, 612, components described in this specification, including the processors 613, 616 and the memories 614, 617 can include multiple processors and memories that can operate in different physical locations and not within the same computing device. For example, some of the instructions 621, 618 and the data 623, 619 can be stored on a removable SD card and others within a read-only computer chip. Some or all of the instructions and data can be stored in a location physically remote from, yet still accessible by, the processors 613, 616. Similarly, the processors 613, 616 can include a collection of processors that can perform concurrent and/or sequential operations. The computing devices 615, 612 can each include one or more internal clocks providing timing information, which can be used for time measurement for operations and programs run by the computing devices 615, 612.

The server computing device 615 can be configured to receive requests to process data from the user computing device 612. For example, the environment 600 can be part of a computing platform configured to provide a variety of services to users, through various user interfaces and/or APIs exposing the platform services. One or more services can be a machine learning framework or a set of tools for generating neural networks or other machine learning models according to a specified task and training data. The user computing device 612 may receive and transmit data specifying target computing resources to be allocated for executing a neural network trained to perform a particular neural network task.

The devices 612, 615 can be capable of direct and indirect communication over the network 660. The devices 615, 612 can set up listening sockets that may accept an initiating connection for sending and receiving information. The network 660 itself can include various configurations and protocols including the Internet, World Wide Web, intranets, virtual private networks, wide area networks, local networks, and private networks using communication protocols proprietary to one or more companies. The network 660 can support a variety of short- and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 660, in addition or alternatively, can also support wired connections between the devices 612, 615, including over various types of Ethernet connection.

Although a single server computing device 615 and user computing device 612 are shown in FIG. 6, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, including non-transitory computer-readable storage media, as one or more computer programs, or a combination of one or more of the foregoing. The computer-readable storage media can be non-transitory, e.g., as one or more instructions executable by a cloud computing platform and stored on a tangible storage device.

In this specification, the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system or be part of multiple systems. One or more processors in one or more locations implementing an example STOC according to aspects of the disclosure can perform the operations shown in the drawings and recited in the claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including,” and the like, should not be interpreted as limiting the subject matter of the claims to the specific examples; rather, the examples are intended to illustrate only one of many possible implementations. Further, the same reference numbers in different drawings can identify the same or similar elements.

1. A system for anomaly detection, comprising one or more processors, wherein the one or more processors are configured to:
receive unlabeled training data comprising a plurality of training examples;
categorize, using a plurality of first machine learning models, each of the training examples as an anomalous training example or non-anomalous training example;
generate a refined set of training data including the training examples categorized as non-anomalous training examples; and
train a second machine learning model, using the refined set of training data, to receive input data and to generate output data indicating whether the input data is anomalous or non-anomalous.

2. The system of claim 1, wherein the unlabeled training data comprises one or more anomalous training examples and one or more non-anomalous training examples.

3. The system of claim 1, wherein the one or more processors are further configured to train the plurality of first machine learning models using the refined set of training data.

4. The system of claim 1, wherein the one or more processors are configured to perform additional iterations of:
categorizing each of the training examples using the plurality of first machine learning models; and
updating, based on the additional iterations, the refined set of training data.

5. The system of claim 4,
wherein the one or more processors are further configured to train a third machine learning model using the refined set of training data, wherein the third machine learning model is trained to receive training examples and to generate one or more respective feature values for each of the received training examples; and
wherein to categorize the unlabeled training data using the plurality of first machine learning models, the one or more processors are configured to process, using the plurality of first machine learning models, respective one or more feature values for each training example of the unlabeled training data, wherein the respective one or more feature values are generated using the third machine learning model.

6. The system of claim 5, wherein the one or more processors are configured to perform additional iterations of training the third machine learning model using the refined set of training data.

7. The system of claim 1, wherein the one or more processors are further configured to:
train each of the first machine learning models using a respective subset of the unlabeled training data;
process a first training example of the unlabeled training data through each of the plurality of first machine learning models to generate a plurality of first scores corresponding to respective probabilities that the first training example is non-anomalous or anomalous;
determine that at least one first score does not meet one or more thresholds; and
in response to the determination that the at least one first score does not meet one or more thresholds, exclude the first training example from the unlabeled training data.

8. The system of claim 7, wherein the one or more thresholds are based on a predetermined percentile value of a distribution of scores corresponding to respective probabilities that training examples in the unlabeled training data are non-anomalous or anomalous.

9. The system of claim 8, wherein the one or more thresholds comprise a plurality of thresholds, each threshold based on the predetermined percentile value of a respective distribution of scores generated from training examples processed by a respective first machine learning model of the plurality of first machine learning models.

10. The system of claim 9, wherein the one or more processors are further configured to:
generate the one or more thresholds based on minimizing, over one or more iterations of an optimization process, respective intra-class variances among anomalous and non-anomalous training examples in the training data.

11. A method for anomaly detection, comprising:
receiving, by one or more processors, unlabeled training data comprising a plurality of training examples;
categorizing, by the one or more processors and using a plurality of first machine learning models, each of the training examples as an anomalous training example or non-anomalous training example;
generating, by the one or more processors, a refined set of training data including the training examples categorized as non-anomalous training examples; and
training, by the one or more processors, a second machine learning model, using the refined set of training data, to receive input data and to generate output data indicating whether the input data is anomalous or non-anomalous.

12. The method of claim 11, wherein the unlabeled training data comprises one or more anomalous training examples and one or more non-anomalous training examples.

13. The method of claim 11, wherein the method further comprises training the plurality of first machine learning models using the refined set of training data.

14. The method of claim 11, wherein the method further comprises performing additional iterations of:
categorizing each of the training examples using the plurality of first machine learning models; and
updating, based on the additional iterations, the refined set of training data.

15. The method of claim 14, wherein the method further comprises training a third machine learning model using the refined set of training data, wherein the third machine learning model is trained to receive training examples and to generate one or more respective feature values for each of the received training examples; and
when categorizing the unlabeled training the unlabeled training data using the plurality of first machine learning models comprises processing, using the plurality of first machine learning models, respective one or more feature values for each training example of the unlabeled training data, wherein the respective one or more feature values are generated using the third machine learning model.

16. The method of claim 11, wherein the method further comprises:
training each of the first machine learning models using a respective subset of the unlabeled training data;
processing a first training example of the unlabeled training data through each of the plurality of first machine learning models to generate a plurality of first scores corresponding to respective probabilities that the first training example is non-anomalous or anomalous;
determining that at least one first score does not meet one or more thresholds; and
in response to determining that the at least one first score does not meet one or more thresholds, excluding the first training example from the unlabeled training data.

17. The method of claim 16, wherein the one or more thresholds are based on a predetermined percentile value of a distribution of scores corresponding to respective probabilities that training examples in the unlabeled training data are non-anomalous or anomalous.

18. The method of claim 17, wherein the one or more thresholds comprise a plurality of thresholds, each threshold based on the predetermined percentile value of a respective distribution of scores generated from training examples processed by a respective first machine learning model of the plurality of first machine learning models.

19. The method of claim 18, wherein the method further comprises:
generating the one or more thresholds based on minimizing, over one or more iterations of an optimization process, respective intra-class variances among anomalous and non-anomalous training examples in the training data.

20. One or more non-transitory computer-readable storage media, having stored thereon, instructions that when executed by one or more processors cause the one or more processors to perform operations comprising:
receiving unlabeled training data comprising a plurality of training examples;
categorizing, using a plurality of first machine learning models, each of the training examples as an anomalous training example or non-anomalous training example;
generating a refined set of training data including the training examples categorized as non-anomalous training examples; and
training a second machine learning model, using the refined set of training data, to receive input data and to generate output data indicating whether the input data is anomalous or non-anomalous.
